(19) United States
(12) Patent Application Publication
(10) Pub. No.: US 2023/0231273 A1
(43) Pub. Date: Jul. 20, 2023

(54) IMPROVED MICROPOROUS MEMBRANE AND DEVICES COMPRISING THE SAME

(71) Applicants: Celgard, LLC, Charlotte, NC (US); ASAHI KASEI KABUSHIKI KAISHA, Tokyo (JP)

(72) Inventors: Hisashi Takeda, Düsseldorf (DE); Kang Karen Xiao, Mississauga (CA); Allen M. Donn, Rock Hill, SC (US); Shinya Hamasaki, Tokyo (JP); Masaki Takahashi, Tokyo (JP)

(21) Appl. No.: 18/009,342

(22) PCT Filed: Jun. 11, 2021
(86) PCT No.: PCT/US2021/036991

§ 371 Date: Dec. 9, 2022

Related U.S. Application Data
(60) Provisional application No. 63/038,555, filed on Jun. 12, 2020.

(51) Int. Cl. H01M 50/457; H01M 50/403; H01M 50/417; H01M 50/489; H01M 10/42; H01M 50/434

(52) U.S. Cl. CPC H01M 50/457; H01M 50/403; H01M 50/417; H01M 50/489; H01M 10/4235; H01M 50/434

(57) ABSTRACT

A multilayer porous membrane with two exterior layers and at least one interior layer. The average pore size of the interior layer is greater than that of either of the two exterior layers. The multilayer porous membrane may be used, for example, as or as part of a battery separator. Compared to prior multilayer porous membranes for battery separators, the multilayer porous membrane herein may exhibit at least one of improved thermal properties, improved anti-metal contamination properties, improved ease of manufacture, and combinations thereof.

### CROSS REFERENCE TO RELATED APPLICATIONS

This application is a 371 U.S. Application claiming priority to PCT/US2021/036991, filed Jun. 11, 2021, which claims priority to U.S. Provisional Patent Application Ser. No. 63/038,555, filed Jun. 12, 2020, which is hereby fully incorporated by reference herein.

### FIELD

This application is directed to an improved multilayer microporous membrane, which may be useful as a battery separator. Particularly, the multilayer microporous membrane described herein may exhibit at least one of the following: improved thermal properties, improved anti-metal contamination properties, and improved ease of manufacture.

### BACKGROUND

Commonly used electrode materials for a secondary battery may contain transition metals including iron (Fe), manganese (Mn), nickel (Ni), cobalt (Co), aluminum (Al), and others. For example, some exemplary electrode materials may include Lithium Nickel Cobalt Manganese Oxide (NMC or NCM), Lithium Iron Phosphate (LFP), Lithium Nickel Manganese Spinel (LMNO), Lithium Nickel Cobalt Aluminum Oxide (NCA), Lithium Manganese Oxide (LMO), Lithium Cobalt Oxide (LCO), or combinations thereof. Some of these electrode materials interact with the electrolyte resulting in the presence of transition metal ions in the electrolyte. Under the right conditions, these metal ions maybe reduced to their metal form. This metal plating will result in dendrite growth. When dendrites grow through the separator contacting both electrodes, a short results.

Another source of metal contamination may be metallic equipment, e.g., brushes, rollers, etc. used to manufacture battery parts and/or batteries. Metallic equipment may be a source of cobalt, copper, or iron ions in the battery.

In view of the foregoing, methods to reduce, mitigate, or eliminate metal contamination in a battery may be desirable.

### SUMMARY

In one aspect, described herein is a multilayer microporous membrane that, when used as a battery separator, may reduce or eliminate metal contamination in a battery, among other things. The multilayer microporous membrane may be used as a separator with metal mitigation properties. It may be particularly useful in a battery where metal contamination is an issue.

The multilayer porous membrane may comprise at least three layers as follows: two exterior layers each individually comprising, consisting of, or consisting essentially of polypropylene; and at least one interior layer comprising, consisting of, or consisting essentially of polypropylene. The average pore size of the interior layer is larger than the average pore size of either or both of the exterior layers.

A pore size ratio of the multilayer porous membrane may be calculated by dividing the average pore size of the interior layers by the average pore size of the exterior layers. In some embodiments, the pore size ratio may be greater than 1.0. In some embodiment, the pore size ratio may be from 1.2 to 5.0, from 1.2 to 4.5, from 1.2 to 4.0, from 1.2 to 3.5, from 1.2 to 3.0, from 1.3 to 2.5, from 1.4 to 2.5, from 1.5 to 2.5, from 1.6 to 2.5, from 1.7 to 2.5, from 1.2 to 2.0, from 1.2 to 1.9, from 1.2 to 1.8, from 1.2 to 1.7, from 1.2 to 1.6, from 1.2 to 1.5, from 1.2 to 1.4, or from 1.2 to 1.3.

Regarding pore size, in some embodiments, an average pore size of the interior layer is 5% or more, 10% or more, 20% or more, 30% or more, 40% or more, or 50% or more than an average pore size of either of or both of the exterior layers.

In some embodiments, the two exterior layers each have an average pore size in a range from 0.05 to 0.5 microns (50 to 500 nm), 0.1 to 0.4 microns (100 to 400 nm), 0.11 to 0.35 microns (110 to 350 nm), 0.12 to 0.3 microns (120 to 300 nm), or 0.15 to 0.3 microns (150 to 300 nm) and their average pore sizes may be the same or different. The average pore size of the interior layer may also be in a range from 0.05 to 0.5 microns (50 to 500 nm).

In some embodiments, the two exterior layers each have an average pore size less than 0.25 microns and their average pore sizes may be the same or different. The average pore size of the interior layer may be greater than 0.25 microns.

In some embodiments the interior layer may comprise, consist of, or consist essentially of a polypropylene having a melt flow rate (MFR) that is different (either higher or lower) than the MFR of a polypropylene in one or both exterior layers.

In some embodiments, the interior layer may comprise, consist of, or consist essentially of a polypropylene homopolymer, copolymer, or terpolymer with an MFR less than 1.0 g/10 min when measured according to JIS K7210. In some embodiments, the MFR may be in the range from 0.1 to 0.75 g/10 min.

In some embodiments, the interior layer may comprise, consist of, or consist essentially of polypropylene and another component. The component may be present in an amount of 1 wt. % to 20 wt. %, or from 5 wt. % to 10 wt. %. The other component may be one or more selected from an elastomer, an ethylene/α-olefin copolymer, a low molecular weight polymer such as polypropylene, a low melting point polymer such as polypropylene, and combinations thereof. In some embodiments, the elastomer may be a styrenic elastomer. The styrenic elastomer may be one or more selected from a block copolymer of styrene and isoprene (SIS), a styrene-ethylene-butylene-styrene (SEBS), a styrene-ethylene-propylene-styrene (SEPS) styrenic block copolymer, a styrene-ethylene-ethylene-propylene-styrene (SEEPS) block co-polymer, a styrene-ethylene-propylene (SEP) block co-polymer, a triblock copolymer having styrene endblocks and a middle block that may be hydrogenated or unhydrogenated, and combinations thereof.

In some embodiments, the multilayer porous membrane may have one interior layer, and in other embodiments, there may be two or more interior layers. In embodiments with two or more interior layers, one of the interior layers may comprise, consist of, or consist essentially of polyethylene, which may provide a shutdown function, and one of the interior layers may comprise, consist of, or consist essentially of polypropylene.

The multilayer porous membrane may have a thickness from 5 to 25 microns or from 5 to 15 microns.

In some embodiments, the multilayer porous membrane may be formed by a co-extrusion method. For example, two or more layers of the structure may be co-extruded together. In embodiments where only one interior layer is present, the interior layer may be co-extruded with at least one exterior layer or with both exterior layers.

In some embodiments, the multilayer porous membrane may be formed by laminating two or more layers together. In embodiments where only one interior layer is present, the interior layer may be laminated to at least one or to both exterior layers.

The multilayer porous membrane may have a puncture strength above 300 gf, 310 gf, 320 gf, 330 gf, 340 gf, or 350 gf at 16 microns.

In another aspect, a battery separator comprising a multilayer porous membrane as described herein is also described. In some embodiments, the battery separator may comprise a coated multilayer porous membrane where a coating has been provided to one or both sides of the multilayer porous membrane. The coating is not so limited, but may be a ceramic coating, a polymer coating, a shutdown coating, a stick/adhesive coating, or combinations thereof

In another aspect, a battery comprising the battery separator described herein is also described. The battery may, in some embodiments have an electrode comprising Lithium Nickel Cobalt Manganese Oxide (NMC or NCM), Lithium Iron Phosphate (LFP), Lithium Nickel Manganese Spinel (LMNO), Lithium Nickel Cobalt Aluminum Oxide (NCA), Lithium Manganese Oxide (LMO), Lithium Cobalt Oxide (LCO), or combinations thereof.

In another aspect, a vehicle comprising a battery as described herein is also described. The vehicle may be a hybrid electric vehicle (HEV) a mild-hybrid electric vehicle (MHEV), or a plug-in hybrid electric vehicle (PHEV).

### DESCRIPTION OF THE FIGURES

FIG. 1 is an SEM of a membrane according to some embodiments described herein.

FIG. 2 is a graph of pore size data according to some inventive embodiments disclosed herein.

FIG. 3 is a graph of pore size data according to some comparative embodiments disclosed therein.

FIG. 4A is a table including data for inventive examples 1, 2, and 3 described herein.

FIG. 4B is a table including data for inventive examples 4, 5, and 6 described herein.

FIG. 4C is a table including data for inventive examples 7, 8, and 9 described herein.

FIG. 5 is a table including data for comparative embodiments described herein.

### DESCRIPTION

The multilayer microporous membrane described herein may exhibit at least one of the following: improved thermal properties, improved anti-metal contamination properties, and improved ease of manufacture. These properties result from its unique structure, which includes a multilayer structure with two exterior layers and at least one interior layer, where the average pore size of the interior layer or layers is larger than that of the exterior layers. This microporous membrane may be particularly useful in secondary batteries comprising electrode materials with transition metals that may form dangerous metal dendrites causing shorts in the cell. Shorts may lead to smoke, fires, and/or explosions. Thus, preventing shorts increases battery safety.

Multilayer Porous Membrane

The structure of the membrane is not so limited, but preferably comprises the following: two exterior layers and at least one interior layer. In some embodiments, the structure may comprise two or more, three or more, four or more, five or more, six or more, seven or more, eight or more, nine or more, or ten or more interior layers. At least one interior layer has an average pore size that is greater than the average pore size of the exterior layers. The average pore size of the exterior layers may be the same or different, but both have an average pore size that is smaller than that of the at least one interior layer.

In some embodiments, the average pore size of the interior layer or layers is 5% or more, 10% or more, 15% or more, 20% or more, 25% or more, 30% or more, 35% or more, 40% or more, 45% or more, or 50% or more larger than the pore size of the two exterior layers. In some embodiments, a pore size ratio of the membrane, which is a ratio of the average pore size of the interior layer(s) to the average pore size of the exterior layers, is 1.05 or more, 1.10 or more, 1.20 or more, 1.30 or more, 1.40 or more, 1.50 or more, 1.60 or more, 1.70 or more, 1.80 or more, 1.90 or more, 2.00 or more, 2.10 or more, 2.10 or more, 2.20 or more, 2.30 or more, 2.40 or more, or 2.50 or more. In some particularly preferred embodiments, a ratio of the average pore size of the interior layer(s) to the average pore size of the exterior layers is 1.20 or more, 1.50 or more, or 1.70 or more. Such membranes exhibit improved metal mitigation.

In some embodiments, the average pore size of the exterior layers may each individually be in range of 0.05 to 1.0 microns (50 to 1,000 nm), from 0.1 to 0.9 microns (100 to 900 nm), from 0.1 to 0.8 microns (100 to 800 nm), from 0.1 to 0.7 microns (100 to 700 nm), from 0.1 to 0.6 microns (100 to 600 nm), from 0.05 to 0.5 microns (50 to 500 nm), from 0.1 to 0.4 microns (100 to 400 nm), from 0.11 to 0.35 microns (110 to 350 nm), or from 0.12 to 0.3 microns (120 to 300 nm), or from 0.15 to 0.3 microns (150 to 300 nm).

In some embodiments, the average pore size of the interior layer may be in range of 0.05 to 1.0 microns, from 0.1 to 0.9 microns, from 0.15 to 0.8 microns, from 0.2 to 0.7 microns, from 0.3 to 0.6 microns, for 0.3 to 0.5 microns, or from 0.3 to 0.4 microns.

In some preferred embodiments, the average pore size of the interior layer is equal to or greater than 0.5, equal to or greater than 0.4 microns, equal to or greater than 0.3 microns, equal to or greater than 0.2 microns, or equal to or greater than 0.1 microns, and the average pore size of the exterior layers is equal to or less than 0.5 microns, equal to or less than 0.4 microns, equal to or less than 0.3 microns, equal to or less than 0.2 microns, or equal to or less than 0.1 microns.

The composition of the layers of the multilayer porous membrane is not so limited and any thermoplastic resin may be used. Furthermore, the composition of each of the layers of the multilayer porous membrane may be the same as or different from each other. For example, in a three layer structure having two exterior layers and one interior layer, the composition of the exterior layers may be the same or different, and the composition of the interior layer may be the same as or different than the composition of either or both of the exterior layers.

In some preferred embodiments the two exterior layers and the at least one interior layer may comprise, consist of, or consist essentially of a polypropylene homopolymer, copolymer, or terpolymer. The polypropylene homopolymer, copolymer, or terpolymer in each of the exterior and interior layers may be the same, e.g., have the same or substantially the same melt flow rate, or may be different, e.g., have a different melt flow rate. The polypropylene used may have a melt flow rate of 0.1 to 2, 0.1 to 1.9, 0.1 to 1.8, 0.1 to 1.7, 0.1 to 1.6, 0.1 to 1.5, 0.1 to 1.4, 0.1 to 1.3, 0.1 to 1.2, 0.1 to 1.1, 0.1 to 1.0, 0.1 to 0.95, 0.1 to 0.9, 0.1 to 0.85, 0.1 to 0.80, 0.1 to 0.75, 0.1 to 0.70, 0.1 to 0.65, 0.1 to 0.60, 0.1 to 0.55, 0.1 to 0.50, 0.1 to 0.45, 0.1 to 0.40, 0.1 to 0.35, 0.1 to 0.30, 0.1 to 0.25, 0.1 to 0.20, or 0.1 to 0.15 when measured according to JIS K7210

In some embodiments, the interior layer may comprise, consist of, or consist essentially of a polypropylene with a lower MFR when measured according to JIS K7210.

For example, the interior layer may comprise, consist of, or consist essentially of a polypropylene polymer, copolymer, or terpolymer having a MFR less than 1.0, less than 0.95, less than 0.9, less than 0.85, less than 0.8, less than 0.75, less than 0.7, less than 0.65, less than 0.6, less than 0.55, less than 0.5, less than 0.45, less than 0.4, less than 0.35, less than 0.3, less than 0.25, less than 0.2, less than 0.15, less than 0.1, or less than 0.05 when measured according to JIS K7210.

The method of achieving the different average pore sizes in the layers of the multilayer porous structures is not so limited. In some embodiments, an additive may be added to the internal layer that allows for the formation of larger pores in that layer when it is co-extruded with the two external layers. For example, an inorganic or organic pore-former or nucleating agent may be added. Also, a polymer or elastomer may be added for this purpose. Different average pore sizes among the layers may also be achieved, for example, by separately extruding and stretching each layer of the structure to form pores. Then, the stretched layers may be laminated together to form the final structure.

In some embodiments, to achieve larger pores, the interior layer may comprise polypropylene and another component that may be added in an amount from 1 wt. % to 20 wt. %, from 2 wt. % to 20 wt. %, from 3 wt. % to 20 wt. %, from 4 wt. % to 20 wt. %, from 5 wt. % to 20 wt. %, from 6 wt. % to 20 wt. %, from 7 wt. % to 20 wt. %, from 8 wt. % to 20 wt. %, from 9 wt. % to 20 wt. %, from 10 wt. % to 20 wt. %, from 11 wt. % to 20 wt. %, from 12 wt. % to 20 wt. %, from 13 wt. % to 20 wt. %, from 14 wt. % to 20 wt. %, from 15 wt. % to 20 wt. %, 19 wt. % to 20 wt. %

For example, it may comprise polypropylene and an elastomer. The elastomer may in some embodiments be a styrenic elastomer. For example, at least one of a block copolymer of styrene and isoprene (SIS) a styrene-ethylene-butylene-styrene (SEBS), a styrene-ethylene-propylene-styrene (SEPS) styrenic block copolymer, a styrene-ethylene-ethylene-propylene-styrene (SEEPS) block co-polymer, a styrene-ethylene-propylene (SEP) block co-polymer, a triblock copolymer having styrene endblocks and a middle block that may be hydrogenated or unhydrogenated, and combinations thereof may be used. In some embodiments, at least one interior layer may contain the elastomer in an amount of 1 wt. % or more, 3 wt. % or more, 5 wt. % or more, or 10 wt. % or more up to about 20 wt. %.

In other preferred embodiments, an ethylene/α-olefin copolymer like an ethylene/propylene copolymer, an ethylene/1-butene copolymer, an ethylene/1-hexene copolymer, an ethylene/1-octene copolymer, a propylene/1-butene copolymer, an ethylene/propylene/1-butene copolymer, or combinations thereof may be added to achieve larger pores in an interior layer. In some embodiments, such ethylene/α-olefin copolymers may be added to an interior layer in an amount of 1 wt. % or more, 3 wt. % or more, 5 wt. % or more, or 10 wt. % or more up to about 20 wt. %.

In other preferred embodiments, a low melting point polypropylene homopolymer, copolymer, or terpolymer may be added to an interior layer to achieve larger pore sizes. A low melting point is a melting point lower than 100° C., lower than 95° C., lower than 90° C., lower than 85° C., lower than 80° C., lower than 75° C., lower than 70° C., lower than 65° C., lower than 60° C., lower than 55° C., lower than 50° C., lower than 45° C., lower than 40° C., lower than 35° C., lower than 30° C., lower than 25° C., lower than 20° C., lower than 15° C., lower than 10° C., or lower than 5° C. In some embodiments, the low melting point polypropylene may be added to an interior layer in an amount of 1 wt. % or more, 3 wt. % or more, 5 wt. % or more, or 10 wt. % or more up to about 20 wt. %.

In other preferred embodiments, a low molecular weight polypropylene homopolymer, copolymer, or terpolymer may be added to an interior layer to achieve larger pore sizes. A low molecular weight polypropylene may have an MFR when measured according to JIS K7210 of 20 or more, 30 or more, 40 or more, 50 or more, 60 or more, 70 or more, 80 or more, 90 or more, 100 or more, 110 or more, 120 or more, 130 or more, 140 or more, 150 or more, 160 or more, 170 or more, 180 or more, or 200 or more. In some embodiments, the low molecular weight polypropylene may be added to an interior layer in an amount of 1 wt. % or more, 3 wt. % or more, 5 wt. % or more, or 10 wt. % or more up to about 20 wt. %.

In some preferred embodiments, the multilayer porous membrane is dry process multilayer porous membrane meaning it was formed without the use of or with minimal use of solvents or oils. A dry process may comprise, consist, or consist essentially of an extrusion step, an annealing step, and one or more stretching steps to form or shape pores. In some embodiments, the membrane may be stretched in one direction (uniaxially) or in two directions (biaxially), or more.

In some embodiments, the multilayer porous film may be formed by co-extruding two or more layers of the structure. In some embodiments, all layers of the structure may be coextruded. For example, when the multilayer porous membrane consists of two exterior layers and one interior layer, all three of the layers may be co-extruded together. Alternatively, one exterior layer and the interior layer may be coextruded and then this structure may be laminated to the other exterior layer which was extruded separately. The layers may be laminated before or after stretching. Another alternative embodiment would be to separately co-extrude two or more layers and laminate these co-extruded layers with one or more additional sets of co-extruded layers.

In some embodiments, the multilayer porous membrane may be formed by laminating three or more monoextruded layers together. For example, the two exterior layers and one interior layer may be separately extruded and then laminated together before or after stretching the separately extruded films.

The thickness of the multilayer porous membrane is not so limited and may be from 1 to 50 microns, from 1 to 40 microns, from 1 to 30 microns, from 1 to 25 microns, from 1 to 20 microns, from 1 to 15 microns, from 1 to 10 microns, or from 1 to 5 microns.

Battery Separator

The battery separator herein is not so limited, and may comprise, consist of, or consist essentially of at least one multilayer porous membrane as described herein. In some embodiments, a coating may be applied to one or both sides of the multilayer porous membrane.

With regard to the coating, the coating is not so limited. It may be a ceramic coating, a polymer coating, a shutdown coating, a stick/adhesive coating, or combinations thereof. The coating thickness is not so limited but may be from 0.1 to 10 microns, from 0.2 to 9 microns, from 0.3 to 8 microns, from 0.4 to 7 microns, from 0.5 to 6 microns, from 0.6 to 5 microns, from 0.7 to 4 microns, from 0.8 to 3 microns, from 0.9 to 2 microns, or from 1 to 5 microns.

A shutdown coating may provide this added safety feature to an all-polypropylene membrane that does not shutdown like a typical PP/PE/PP shutdown separator. Provision of a ceramic coating may further add to the anti-metal contamination function of the separator by helping to block dendrite growth that may result in shorting of the battery.

Battery or Device

Uses for the membrane or battery separator described herein are not so limited. The membrane, for example, may be used as part of a battery separator for a secondary battery, a capacitor, and the like. The membrane may also be useful for textiles, filters, HVAC applications, fuel cell applications, and the like.

The type of battery that the battery separator may be used in is also not limited. In some preferred embodiments, the battery separator may be useful in any battery where metal dendrite growth is a concern. Metal dendrite growth may result from lithium or transition metal deposits and growth as described herein. In these devices, the membrane or battery separator described herein may help mitigate metal dendrite growth.

Vehicle

The type of vehicle in which the battery described herein is used is not so limited. For example, the vehicle may be a hybrid electric vehicle (HEV), a mild-hybrid electric vehicle (MHEV), a plug-in hybrid electric vehicle (PHEV), or the like.

The products and devices of the appended claims are not limited in scope by the specific products and devices described herein, which are intended as illustrations of a few aspects of the claims and any products and devices that are functionally equivalent are intended to fall within the scope of the claims. Various modifications of the products and devices in addition to those shown and described herein are intended to fall within the scope of the appended claims. Further, while only certain representative products and devices disclosed herein are specifically described, other combinations of the products and devices also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” may be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

The present invention may be embodied in other forms without departing from the spirit and the essential attributes thereof, and, accordingly, reference should be made to the appended claims, rather than to the foregoing specification, as indicating the scope of the invention. Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that may be performed it is understood that each of these additional steps may be performed with any specific embodiment or combination of embodiments of the disclosed methods.

The foregoing written description of structures and methods has been presented for purposes of illustration only. Examples are used to disclose exemplary embodiments, including the best mode, and also to enable any person skilled in the art to practice the invention, including making and using any devices or systems and performing any incorporated methods. These examples are not intended to be exhaustive or to limit the invention to the precise steps and/or forms disclosed, and many modifications and variations are possible in light of the above teaching. Features described herein may be combined in any combination. Steps of a method described herein may be performed in any sequence that is physically possible. The patentable scope of the invention is defined by the appended claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The products and devices of the appended claims are not limited in scope by the specific products and devices described herein, which are intended as illustrations of a few aspects of the claims. Any products and devices that are functionally equivalent are intended to fall within the scope of the claims. Various modifications of the products and devices in addition to those shown and described herein are intended to fall within the scope of the appended claims. Further, while only certain representative products and devices disclosed herein are specifically described, other combinations of the products and devices also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

As used in the specification and the appended claims, the singular forms “a,” “an,” and “the” include plural referents unless the context clearly dictates otherwise. Ranges may be expressed herein as from “about” or “approximately” one particular value, and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. “Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers, or steps. The terms “consisting essentially of” and “consisting of” may be used in place of “comprising” and “including” to provide for more specific embodiments of the invention and are also disclosed. “Exemplary” or “for example” means “an example of” and is not intended to convey an indication of a preferred or ideal embodiment. Similarly, “such as” is not used in a restrictive sense, but for explanatory or exemplary purposes.

Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

Additionally, the invention illustratively disclosed herein suitably may be practiced in the absence of any element which is not specifically disclosed herein.

### EXAMPLES

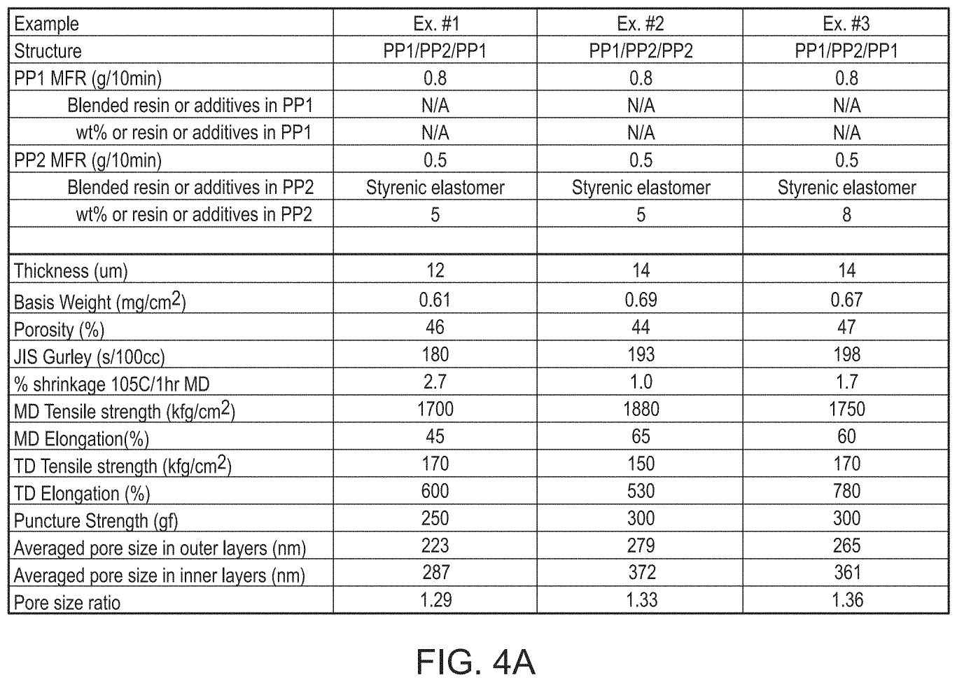

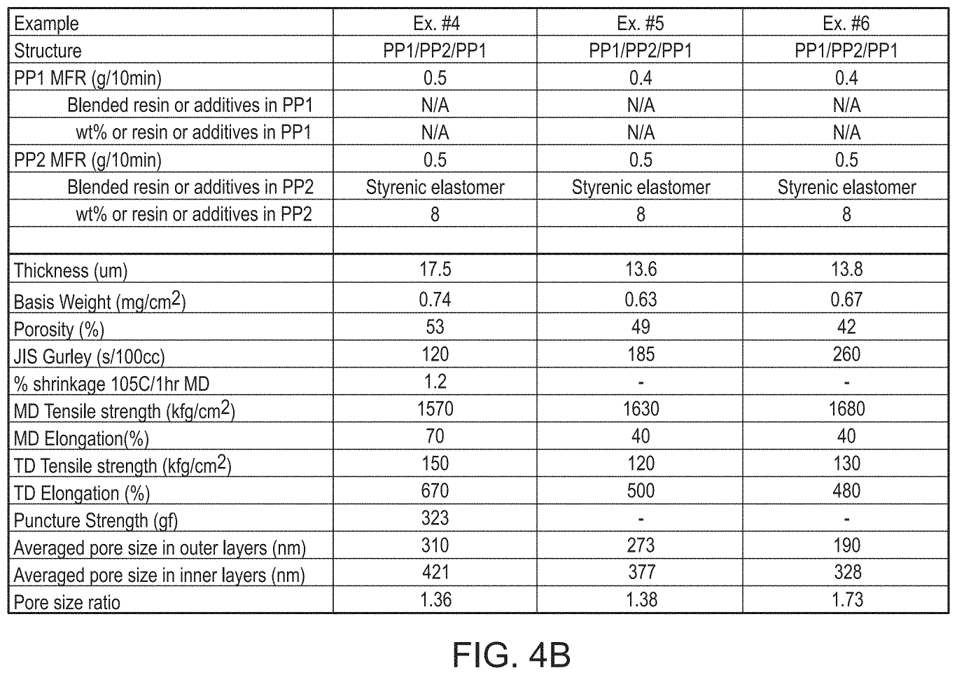

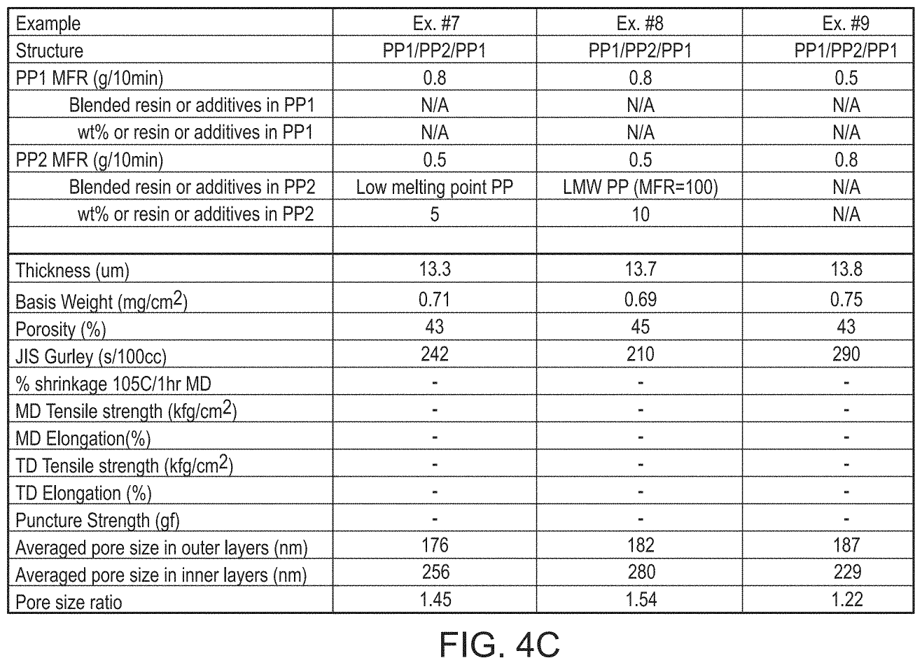

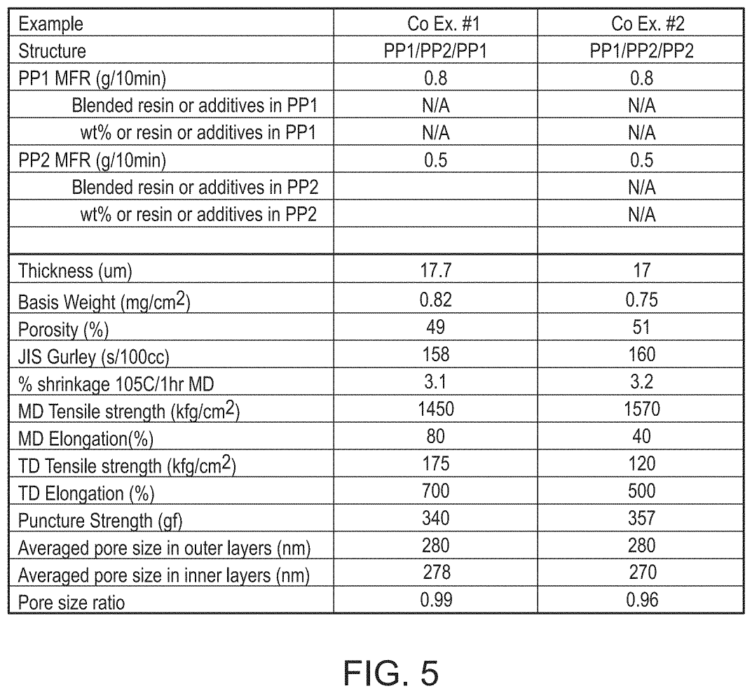

Inventive Examples and Comparative Examples were formed by a dry-stretch process, including co-extruding polypropylene composition 1 (PP1) and polypropylene composition 2 (PP2) to form a membrane having the following trilayer structure PP1/PP2/PP1. The PP1 and PP2 for each of the Examples are as defined in the tables in FIGS. 4A, 4B, 4C and FIG. 5.

For Example, in Example 1, PP1 is a polypropylene having a MFR of 0.8 g/10 min, and PP2 is a blend of is a polypropylene having a MFR of 0.5 g/10 min and a styrenic elastomer, wherein the amount of styrenic elastomer is 5 wt. %.

In Example 2, PP1 is a polypropylene with an MFR of 0.8 g/10 min, and PP2 is a blend of a polypropylene with an MFR of 0.5 g/10 min and a styrenic elastomer, which is the same as that used in Example 1, in an amount of 5 wt. %.

In Example 3, PP1 is a polypropylene having an MFR of 0.8 g/10 min and PP2 is a blend of a polypropylene having an MFR of 0.5 g/10 min and 8 wt. % of a styrenic elastomer, which is the same as that used in Example 1.

In Example 4, PP1 is a polypropylene having an MFR of 0.5 g/10 min, and PP2 is a blend of a polypropylene having an MFR of 0.5 g/10 min and 8 wt. % of a styrenic elastomer, which is the same as that used in Example 1.

For Example 5, PP1 is a polypropylene having an MFR of 0.4 g/10 min, and PP2 is a blend of a polypropylene having an MFR of 0.5 g/10 min and 8 wt. % of a styrenic elastomer, which is the same as that used in Example 1.

For Example 6, PP1 is a polypropylene having an MFR of 0.4 g/10min, and PP2 is a blend of a polypropylene having an MFR of 0.5 g/10 min and 8 wt. % of a styrenic elastomer, which is the same as that used in Example 1.

For Example 7, PP1 is a polypropylene having an MFR of 0.8 g/10 min, and PP2 is a blend of a polypropylene having an MFR of 0.5 g/10 min and 5 wt. percentage a low melting point PP having a melting point less than 100° C.

For Example 8, PP1 is a polypropylene having an MFR of 0.8 g/10 min, and PP2 is a blend of a polypropylene having an MFR of 0.5 g/10 min and 10 wt. % of a low molecular weight PP having an MFR of 100 g/10 min.

For Example 9, PP1 comprises a polypropylene having an MFR of 0.5 g/10 min and PP2 comprises a polypropylene having an MFR of 0.8 g/10 min. PP2 is not a blend.

For Comparative Example 1, PP1 comprises a polypropylene having an MFR of 0.8 g/10 min and PP2 comprises a polypropylene having an MFR of 0.5 g/10 min. PP2 is not a blend.

For Comparative Example 2, PP1 comprises a polypropylene having an MFR of 0.8 g/10 min and PP2 comprises a polypropylene having an MFR of 0.5 g/10 min. PP2 is not a blend.

The membranes of Examples 1-9 and Comparative Examples 1-2 were analyzed, and the results are presented in the Tables in FIGS. 4A, 4B, 4C, and FIG. 5. The pore size ratio was obtained by calculating the average pore size of the interior layer and the average pore size of the exterior layers, and dividing the average pore size of the interior layer by the average pore size of the exterior layers. Average pore size was measured as follows:

### Area-Averaged Major Pore Size

Area-averaged major pore size was measured by image analyzing of cross-sectional Scanning Electron Microscope (SEM) of a membrane. Cross-sectional SEM was measured by the following procedures;
1) Specimen for cross-sectional SEM: a film sample dyed with Ruthenium (Ru) was processed by the freeze fracture method in which the orientation of fracture was parallel to MD.
2) Conditions for SEM observation: the specimen was mounted on stubs with a conductive carbon paste, then the mounted sample was dried, and then Osmium plasma coating was applied using Osmium coater (Vacuum Device Corporation) to give conductivity to the specimen. The Osmium plasma coating was conducted in the following conditions; discharge voltage gain of 4.5, discharge time of 0.5sec.
3) S-4800(Hitachi High-Technologies Corporation) was used for SEM observation with the following conditions; accelerating voltage: 1 kV, working distance: 5 mm, Magnification: 5,000, detected signal: LA10. Three points were randomly selected to observe.
   The obtained SEM image was converted into binary image by the ImageJ software with Otsu method in order to distinguish the pore region from domains composed of resin. Area-averaged major pore size was calculated by the following equation, where x̅_̅{̅w̅}̅ is area-averaged pore size, xᵢ is major pore size of a certain pore, wᵢ is area of the pore, n is the number of pores

$$\overline{{x}_{w}} = \frac{{\sum }_{i = 1}^{n} {x}_{i} {w}_{i}}{{\sum }_{i = 1}^{n} {w}_{i}}$$

The pores that were partially included at the edge of the image or the pores less than 0.001um² in the image were excluded from the calculation.

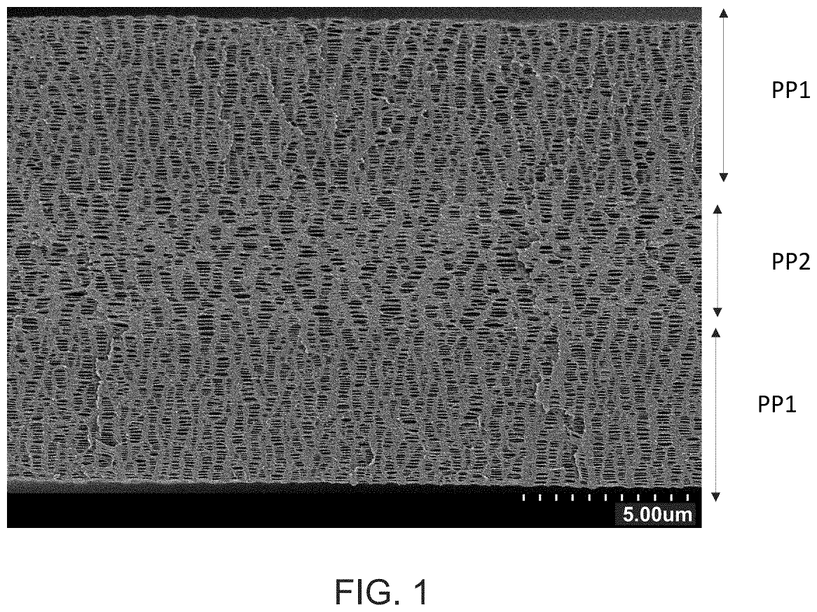

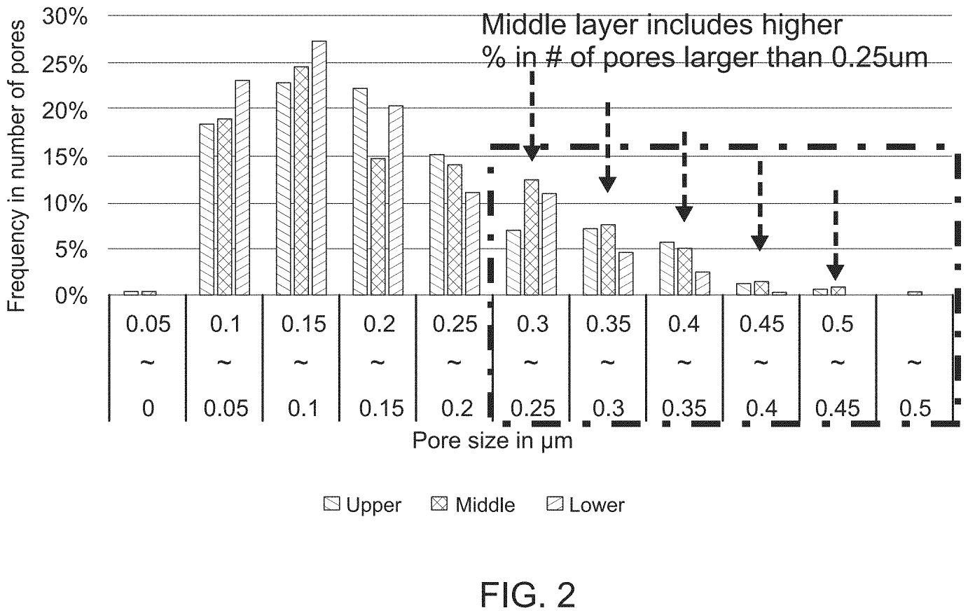

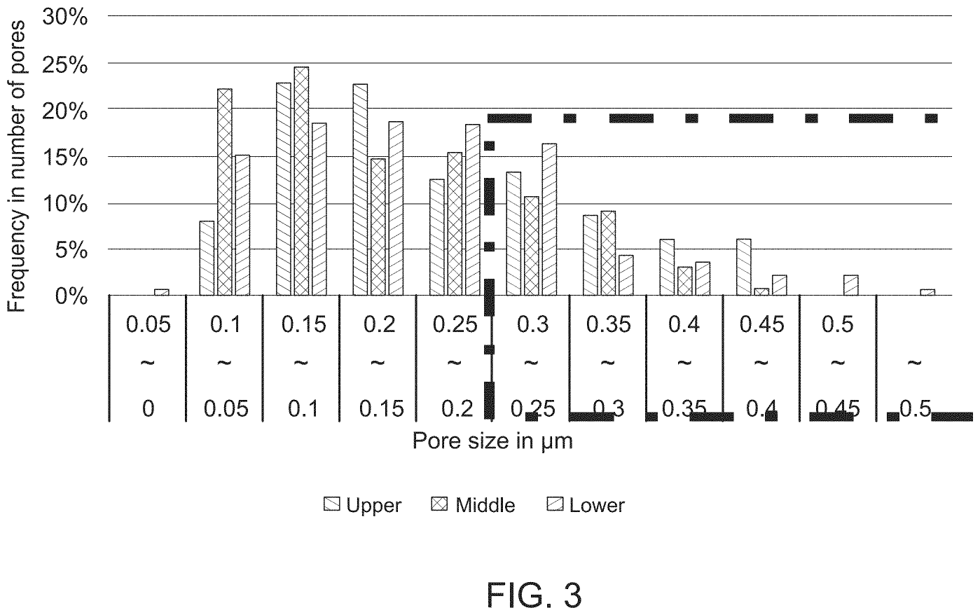

The membrane of Example 1 had a structure as shown in FIG. 1. Pore distribution in the layers of the sample of Example 1 were measured, and are as shown in FIG. 2 Pore distribution in the layers of the sample of Comparative Example 2 was also measured, and are as shown in FIG. 3. Comparative Example 2 and Example 1 are the same except that the interior layer of Example 1 comprises a blend with a styrenic elastomer. Membranes were also evaluated for their ability to mitigate metal growth, and Examples 6 and 8 showed the best results by exhibiting more metal growth mitigation. Without wishing to be bound by any particular theory, it is believed that a higher pore size ratio corresponds to better metal growth mitigation. Metal growth mitigation can be replicated by using a small coin cell and checking how the separator in the cell mitigates the growth of certain metal from anode to cathode during a charging cell cycle. For example, a ratio above 1.2, above 1.3, above 1.4, above 1.5, above 1.6, above 1.7, above 1.8, above 1.9, or above 2.0 may be preferred. In the Examples, the highest pore size ratio was achieved using a blend as shown in Example 6.

It is shown that Example 1 has larger pores in the middle layer and smaller pores in the exterior layer. It is believed that the addition of styrenic elastomer in the middle layer is responsible for this difference, but there may be other ways to achieve the same result, i.e., larger pores in the middle layer. For example, addition of a nucleating agent may achieve the same effect. Further, an example where the outer layers and the middle layer are extruded separately, then laminated together and stretched may be used to form a structure with larger pores in the middle layer. Further still, an example where the outer layers and the middle layer are extruded and stretched separately and then laminated together may be used to form a structure with larger pores in the middle layers. In such a structure, it may not be necessary to add anything to the middle layer to form large pores. Larger pores may be formed by stretching the middle layer more.

1. A dry-process multilayer porous membrane comprising:
two exterior layers, wherein each of the two exterior layers comprise, consist of, or consist essentially of polypropylene; and
one or more interior layer comprising, consisting of, or consisting essentially of polypropylene, wherein the average pore size of the interior layer(s) is larger than the average pore size of the exterior layers.

2. The multilayer porous membrane of claim 1, wherein a pore size ratio of the multilayer porous membrane is 1.2 or more, wherein a pore size ratio is determined by the following formula:
(average pore size of the interior layer or layers)/(average pore size of the exterior layers).

3. The multilayer porous membrane of claim 2, wherein the pore size ratio is 1.3 or more, 1.4 or more, 1.5 or more, or 1.6 or more.

4. (canceled)

5. (canceled)

6. (canceled)

7. The multilayer porous membrane of claim 2, wherein the pore size ratio is 1.7 to 2.5.

8. The multilayer porous membrane of claim 1, wherein the multilayer porous membrane is formed by coextruding at least one exterior layer with at least one interior layer, or by coextruding both exterior layers with at least one interior layer.

9. (canceled)

10. The multilayer porous membrane of claim 1, wherein the multilayer porous membrane is formed by laminating at least one exterior layer to at least one interior layer, or by laminating both exterior layers with at least one interior layer.

11. (canceled)

12. The multilayer porous membrane of claim 1, wherein at least one interior layer comprises, consists of, or consists essentially of a blend of polypropylene and another component that is one or more selected from an elastomer, an ethylene/a—olefin copolymer, a low molecular weight polymer such as polypropylene, a low melting point polymer such as polypropylene, and combinations thereof.

13. The multilayer porous membrane of claim 12, wherein the another component is added in an amount from 1 wt. % to 20 wt. % or in an amount from 5 wt. % to 20 wt. %.

14. (canceled)

15. The multilayer porous membrane of claim 12, wherein the another component is an elastomer, and the elastomer is a styrenic elastomer that may be one or more selected from a block copolymer of styrene and isoprene (SIS), a styrene-ethylene-butylene-styrene (SEBS), a styrene-ethylene-propylene-styrene (SEPS) styrenic block copolymer, a styrene-ethylene-ethylene-propylene-styrene (SEEPS) block co-polymer, a styrene-ethylene-propylene (SEP) block co-polymer, a triblock copolymer having styrene endblocks and a middle block that may be hydrogenated or unhydrogenated, and combinations thereof.

16. (canceled)

17. (canceled)

18. (canceled)

19. (canceled)

20. The multilayer porous membrane of claim 1, wherein the at least one interior layer comprises, consists of, or consists essentially of a polypropylene homopolymer with an MFR that is less than 1.0 g/10 min when measured according to JIS K7210 or that is from 0.1 to 0.75 g/10 min when measured according to JIS K7210.

21. (canceled)

22. The multilayer porous membrane of claim 1, wherein an average pore size of the one or more interior layers is 5% or more, 10% or more, 20% or more, 30% or more, 40% or more, or 50% or more larger than an average pore size of either of or both of the exterior layers.

23. (canceled)

24. (canceled)

25. (canceled)

26. (canceled)

27. (canceled)

28. The multilayer porous membrane of claim 1, wherein the two exterior layers each have an average pore size in a range from 0.05 to 0.5 microns (50 to 500 nm), or have an average pore size less than 0.25 microns (250 nm), and their average pore sizes may be the same or different.

29. The multilayer porous membrane of claim 1, wherein the at least one interior layer has an average pore size in a range from 0.05 to 0.5 microns (50 to 500 nm), or has an average pore size greater than 0.25 microns (250 nm).

30. (canceled)

31. (canceled)

32. The multilayer porous membrane of claim 1, wherein at least one interior layer comprises a polypropylene with an MFR that is different (smaller or larger) than a polypropylene used in at least one of the outer layers.

33. The multilayer porous membrane of claim 1, having a thickness from 5 to 25 microns or from 5 to 15 microns.

34. (canceled)

35. The multilayer porous membrane of claim 1, comprising only one interior layer.

36. The multilayer porous membrane of claim 1, comprising two or more interior layers, wherein one of the interior layers may comprise, consists of, or consists essentially of polyethylene, which may provide a shutdown function, and one of the interior layers comprises, consists of, or consists essentially of polypropylene.

37. (canceled)

38. The multilayer porous membrane of claim 1, having a puncture strength above 300 gf at 16 microns thickness.

39. (canceled)

40. A battery separator comprising the multilayer porous membrane of claim 1, wherein a coating may be provided on one or both sides of the multilayer porous membrane, and wherein the coating may be a ceramic coating, a polymer coating, a shutdown coating, a sticky/adhesive coating, or combinations thereof.

41. (canceled)

42. (canceled)

43. A battery comprising the battery separator of claim 40, wherein an electrode of the battery may comprise Lithium Nickel Cobalt Manganese Oxide (NMC or NCM), Lithium Iron Phosphate (LFP), Lithium Nickel Manganese Spinel (LMNO), Lithium Nickel Cobalt Aluminum Oxide (NCA), Lithium Manganese Oxide (LMO), Lithium Cobalt Oxide (LCO), or combinations thereof.

44. (canceled)

45. (canceled)

46. (canceled)

47. (canceled)

48. The multilayer porous membrane of claim 1, wherein the multilayer porous membrane is formed by at least one of:
coextruding at least one exterior layer with at least one interior layer,
coextruding both exterior layers with at least one interior layer,
laminating at least one exterior layer to at least one interior layer, and
laminating both exterior layers with at least one interior layer;
and, wherein at least one interior layer comprises, consists of, or consists essentially of a blend of polypropylene and another component that is one or more selected from an elastomer, an ethylene/α-olefin copolymer, a low molecular weight polymer such as polypropylene, a low melting point polymer such as polypropylene, and combinations thereof.

49. The multilayer porous membrane of claim 1, wherein the multilayer porous membrane is formed by at least one of:
coextruding at least one exterior layer with at least one interior layer,
coextruding both exterior layers with at least one interior layer,
laminating at least one exterior layer to at least one interior layer, and
laminating both exterior layers with at least one interior layer;
and wherein at least one interior layer comprises, consists of, or consists essentially of a polypropylene homopolymer with an MFR that is less than 1.0 g/10 min when measured according to JIS K7210 or that is from 0.1 to 0.75 g/10 min when measured according to JIS K7210.

50. The multilayer porous membrane of claim 1, wherein the multilayer porous membrane is formed by at least one of:
coextruding at least one exterior layer with at least one interior layer,
coextruding both exterior layers with at least one interior layer,
laminating at least one exterior layer to at least one interior layer, and
laminating both exterior layers with at least one interior layer;
and wherein an average pore size of the one or more interior layers is 5% or more, 10% or more, 20% or more, 30% or more, 40% or more, or 50% or more larger than an average pore size of either of or both of the exterior layers.

51. The multilayer porous membrane of claim 1, wherein the multilayer porous membrane is formed by at least one of:
coextruding at least one exterior layer with at least one interior layer,
coextruding both exterior layers with at least one interior layer,
laminating at least one exterior layer to at least one interior layer, and
laminating both exterior layers with at least one interior layer;
and wherein the two exterior layers each have an average pore size in a range from 0.05 to 0.5 microns (50 to 500 nm), or have an average pore size less than 0.25 microns (250 nm), and their average pore sizes may be the same or different.

52. The multilayer porous membrane of claim 1, wherein the multilayer porous membrane is formed by at least one of:
coextruding at least one exterior layer with at least one interior layer,
coextruding both exterior layers with at least one interior layer,
laminating at least one exterior layer to at least one interior layer, and
laminating both exterior layers with at least one interior layer;
and wherein the at least one interior layer has an average pore size in a range from 0.05 to 0.5 microns (50 to 500 nm), or has an average pore size greater than 0.25 microns (250 nm).

53. The multilayer porous membrane of claim 1, wherein the multilayer porous membrane is formed by at least one of:
coextruding at least one exterior layer with at least one interior layer,
coextruding both exterior layers with at least one interior layer,
laminating at least one exterior layer to at least one interior layer, and
laminating both exterior layers with at least one interior layer;
and wherein at least one interior layer comprises a polypropylene with an MFR that is different (smaller or larger) than a polypropylene used in at least one of the outer layers.

54. The multilayer porous membrane of claim 1, wherein the multilayer porous membrane is formed by at least one of:
coextruding at least one exterior layer with at least one interior layer,
coextruding both exterior layers with at least one interior layer,
laminating at least one exterior layer to at least one interior layer, and
laminating both exterior layers with at least one interior layer;
and having a thickness from 5 to 25 microns or from 5 to 15 microns.

55. The multilayer porous membrane of claim 1, wherein the multilayer porous membrane is formed by at least one of:
coextruding at least one exterior layer with at least one interior layer,
coextruding both exterior layers with at least one interior layer,
laminating at least one exterior layer to at least one interior layer, and
laminating both exterior layers with at least one interior layer;
and comprising only one interior layer.

56. The multilayer porous membrane of claim 1, wherein the multilayer porous membrane is formed by at least one of:
coextruding at least one exterior layer with at least one interior layer,
coextruding both exterior layers with at least one interior layer,
laminating at least one exterior layer to at least one interior layer, and
laminating both exterior layers with at least one interior layer;
and comprising two or more interior layers, wherein one of the interior layers may comprise, consists of, or consists essentially of polyethylene, which may provide a shutdown function, and one of the interior layers comprises, consists of, or consists essentially of polypropylene.

57. The multilayer porous membrane of claim 1, wherein the multilayer porous membrane is formed by at least one of:
coextruding at least one exterior layer with at least one interior layer,
coextruding both exterior layers with at least one interior layer, laminating at least one exterior layer to at least one interior layer, and
laminating both exterior layers with at least one interior layer;
and having a puncture strength above 300 gf at 16 microns thickness.

58. A battery separator comprising the multilayer porous membrane of claim 1, wherein the multilayer porous membrane is formed by at least one of:
coextruding at least one exterior layer with at least one interior layer,
coextruding both exterior layers with at least one interior layer,
laminating at least one exterior layer to at least one interior layer, and
laminating both exterior layers with at least one interior layer;
and wherein a coating may be provided on one or both sides of the multilayer porous membrane, and wherein the coating may be a ceramic coating, a polymer coating, a shutdown coating, a sticky/adhesive coating, or combinations thereof.

59. A battery separator comprising the multilayer porous membrane of claim 1, wherein the exterior layers and an interior layer are coextruded together, and wherein a coating may be provided on one or both sides of the multilayer porous membrane, and wherein the coating may be a ceramic coating, a polymer coating, a shutdown coating, a sticky/adhesive coating, or combinations thereof.
